(19) United States
(12) Patent Application Publication
(10) Pub. No.: US 2013/0307694 A1
(43) Pub. Date: Nov. 21, 2013

(54) ELECTRICITY/POWER METERING SYSTEM AND METHOD

(71) Applicant: Roni AMAR, Petah Tikva (IL)

(72) Inventor: Roni AMAR, Petah Tikva (IL)

(21) Appl. No.: 13/472,001

(22) Filed: May 15, 2012

(51) Int. Cl. G08B 21/00

(52) U.S. Cl. 340/637

(57) ABSTRACT

A power supervising system, network and method, the system comprising a domestic unit and at least one auxiliary unit, said domestic unit comprising: digital power meter; data reading, storage and processing means; tampering preventing means: display means; alarm means and communication means for communicating with said at least one auxiliary unit or with a control center of a power supplier; said at least one auxiliary unit comprising: an encasement; breach sensing means; digital power reading and data storage means; communication means for communicating with said domestic unit or said control center of said power supplier.

### FIELD OF THE INVENTION

The present invention pertains to prevention of power theft or unauthorized use of power. More particularly, the present invention pertains to electricity/power meters, system and method that prevent theft or unauthorized or unlawful use of electricity/power.

### BACKGROUND

Electricity is a vital source of energy that makes the foundation of modern life. The increasing requirement for electric power due to constant growth of population and increasing private and industrial needs make electricity both a desirable and expensive basic product. Lower sock-economic sectors often attempt to cut electricity spending by bypassing the power line of the electricity grid or tampering with electricity meters. This leads to loss of electricity resources to the power supplier which is not compensated by proper billing. It also compromises the ability to withstand high loads at peak daily or seasonal consumption. Thus, the general public of electricity consumers is also offended by power theft. On the other hand, the action of power theft puts the illegal consumers in harms way and sometimes ends up in electrocution fatalities.

The power supplier is, thus, required to employ field personnel to constantly monitor the integrity of the power grid and supervise the right use of power meters. This compounds the expenses the power supplier is required to make, which in turn is reflected in the power billing to the end customers. The overall result is a rise in electricity costs both to the supplier and customers.

An electricity meter or energy meter is a device that measures the amount of electric energy consumed by a residence, business, or an electrically powered device. Periodic readings of electric meters establish billing cycles and energy used during a cycle and requires the use of field personnel. The meters fall into two basic categories: electro mechanical and electronic. Electronic meters display the energy used on an LAD or LED display, and can also transmit readings to remote places. In addition to measuring energy used, electronic meters can also record other parameters of the load and supply such as maximum demand, power factor and reactive power used etc. They can also support time-of-day billing, for example, recording the amount of energy used during on-peak and off-peak hours. Electronic meters now use low-power radio, GEM, GPS, Bluetooth, IDA, as well as HRS-485 wired link. The meters can store the entire usage profiles with time stamps and relay them at a click of a button. The demand readings stored with the profiles accurately indicate the load requirements of the customer. This load profile data is processed at the utilities for billing and planning purposes.

In facing increased power consumption, a power supplier takes different tactics for daily or seasonal management of power supply. Lower prices are offered for power consumption at off-peak hours of the day to industrial, business and private customers as incentives to reduce load at high-peak hours. Electricity suppliers may wish to charge customers different tariffs at different times of the day to better reflect the costs of generating and transmitting power. Domestic variable-rate meters generally permit two to three tariffs (“peak”, “off-peak” and “shoulder”) and in such installations a simple electro mechanical time switch may be used. Historically, these have often been used in conjunction with electrical storage heaters or hot water storage systems. Multiple tariffs are made easier by time of use (THOU) meters which incorporate or are connected to a time switch and which have multiple registers. Switching between the tariffs may happen via a radio-activated switch rather than a time switch to prevent tampering with a sealed time switch to obtain cheaper electricity. Large commercial and industrial premises may use electronic meters which record power usage in blocks of half an hour or less. This is because most electricity grids have demand surges throughout the day, and the power supplier may wish to give price incentives to large customers to reduce demand at these times.

Remote meter reading saves the cost of a human meter reader and the resulting mistakes, but it also allows more measurements, and remote provisions. Many smart meters now include a switch to interrupt or restore service.

Traditional electricity meters require field reading by power supplier personnel, are time and resources consuming and not client-friendly. In addition, they are the most prone to tampering with. Power suppliers often install remote-reporting meters specifically to enable remote detection of tampering, and specifically to discover energy theft. The change to smart power meters is useful to stop energy theft. When tampering is detected, the normal tactic, legal in most areas of the USA for example, is to switch the customer to a “tampering” tariff charged at the meter's maximum designed current.

A common method of tampering on older meters is to attach magnets to the outside of the meter. Newer computerized meters usually have counter-measures against tampering. ARM (Automated Meter Reading) meters often have sensors that can report opening of the meter cover, magnetic anomalies, extra clock setting, glued buttons, inverted installation, reversed or switched phases etc. Some tampers bypass the meter, wholly or in part. Safe tampers of this type normally increase the neutral current at the meter. Most split-phase residential meters in the United States are unable to detect neutral currents. However, modern tamper-resistant meters can detect and bill it at standard rates. Disconnecting a meter's neutral connector is unsafe because shorts can then pass through people or equipment rather than a metallic ground to the generator.

The standard business model of electricity retailing involves the electricity supplier billing the customer for the amount of energy used in the previous month or quarter. A prepayment meter may be installed in some cases for certain clients. This requires the customer to make advance payment before electricity can be used. If the available credit is exhausted then the supply of electricity is cut off by a relay. In the UK, mechanical prepayment meters used to be common in rented accommodation. Disadvantages of these include the need for regular visits to remove cash, and risk of theft of the cash in the meter.

Modern solid-state electricity meters, in conjunction with smart cards, remove these disadvantages. Such meters are commonly used for customers considered to be a poor credit risk. Recently smartcards are introduced as much more reliable tokens that allow two way data exchange between meter and the utility. Smart meters offer additional functionality including a real-time or near real-time reads, power outage notification, and power quality monitoring. They allow price setting agencies to introduce different prices for consumption based on the time of day and the season.

In settings when energy savings during certain periods are desired, meters may measure demand, the maximum use of power in some interval. In some areas meters have relays for demand response shedding of loads during peak load periods.

Still, most domestic electricity meters must be read manually, whether by a representative of the power supplier or the customer. Where the customer reads the meter, the reading may be supplied to the power company by telephone, mail or over the internet. The electricity supplier will normally require a visit by its representative at least annually in order to verify customer-supplied readings and to make a basic safety check of the meter. It does not provide control on power consumption because the billing is in post-paid method.

Despite the solutions currently available for tampering-resistant and customer-friendly electricity/power meters, the variety of power meters in the market does not enable unification of power metering and monitoring, making power theft more feasible. In addition, such power meters do not resolve the problem of bypassing the power grid that shifts electricity out of the power line without reaching the meter and monitored by it. This way, power is supplied without being counted and recorded by the meters.

It is, therefore, an objective of the present invention to provide a system and method for an advanced overall solution for the problem of power theft and unlawful or unauthorized consumption of power.

In yet another objective, the present invention provides a customized customer-friendly power metering system and method.

In yet another objective, the present invention provides power metering system and method that impart improved control on power consumption to the customer.

In yet another objective, the present invention provides a power metering system and method that add functionalities operable by the consumers.

In yet another objective, the present invention provides a system and method for metering power that reduces use of field personnel and auxiliary supporting staff.

In yet another objective, the present invention provides a system and method for metering power that is more economic to both power suppliers and consumers and that is more environment-friendly.

This and other objectives of the present invention will become apparent as the description proceeds.

### SUMMARY OF THE INVENTION

The present invention provides a system and method for preventing power theft or unlawful or unauthorized use of power that is beneficial to both the power supplier and power consumers. The power supplier benefits in several aspects: Absolute prevention of power theft by applying an effective system for monitoring power consumption; effective alarming in attempts to breach the integrity of the power system; eliminating expenses on field reading of power meters; reducing incentive for power theft by lower socio-economic sectors; unifying the power reading system; applying direct communication between domestic power meters and the power supplier control center; the direct communication enables various operations such as direct meter reading, charging customer account at the supplier, managing total load based on real-time information received from the power meters at on- and off-peak hours or seasons.

The power consumers also benefit in the application of the system and method of the present invention. Such benefits are preventing power theft by neighbor consumers; saving power by receiving real-time monitoring of power consumption and detailed information on power consumption of different appliances; receiving accumulated information on power consumption, which may also be analyzed according to the different appliances used; remote controlling of power consumption enabling turning on and off different appliances.

In one aspect, the present invention provides a supervising system for ensuring registration and payment for use of electricity/power. In particular, the present invention provides a supervising system for monitoring, counting, registering and preventing unlawful or unauthorized use of electricity/power and tampering with the power meters.

In one particular embodiment, the supervising system of the present invention comprises a power consumption supervising system that comprises first and second electricity/power units. One electricity/power unit is installed in a local electricity/power monitoring cabinet of a household, business, factory, plant, office, workplace and the like. The local power unit is also referred to hereafter as the domestic unit. The second electricity/power unit is installed before the exit point of a power line that supplies power to the household, factory, plant, office, workplace and the like, also referred to hereafter as the auxiliary unit.

In still another embodiment, the supervising system further comprises communication means between the domestic and auxiliary units.

In still another embodiment, the communication means are wireless means installed in the domestic and auxiliary units or wired communication means connecting the domestic and auxiliary units.

In one embodiment, the data of power consumption can be transmitted from the domestic unit to a local computer, stationary or portable and displayed on it. In still another embodiment, the data of power consumption can also be transmitted to and displayed on a central computer of the power supplier. In still another embodiment, the power consumption data can be transmitted with any acceptable data transmission means, e.g. through internet landlines, WifFi.

In still another embodiment, communication between the domestic and auxiliary units is made through the power line that connects to the electricity system of the household, business, plant, factory, office, workplace and the like. In one particular embodiment, the communication through the power line establishes direct communication between the domestic power unit and the power supplier over the power grid.

In still another embodiment, the domestic unit comprises a digital electricity counter, display means for displaying counter reading, alarm means for alarming against tampering with the unit and disablement means for disabling the functionalities of the unit upon detection of attempts to tamper with it or to breach the integrity of the power system.

In still another particular embodiment, the domestic unit comprises a smart card. The smart card comprises communication functionalities enabling the unit to communicate with the auxiliary unit or with the power supplier, payment functionalities enabling prepayment for power consumption, setting functionalities enabling to insert settings of monitoring, supervising, operating and shutting off of power-consuming or power-depending activities in the household, plant, factory, office, workplace and the like. In still another particular embodiment, the smart card comprises functionalities for accumulating data on power consumption and analyzing this data according to the different appliances and/or loads used or according to daily, weekly, monthly or seasonally periods of time. The accumulated and analyzed data can be displayed on a screen o the power meter or transmitted to a remote display.

In one particular embodiment, a customer of a power supplier receives a code for recharging his or her account at the power supplier. The code is typed in to the domestic unit. The domestic unit transmits instructions to recharge the customer account at the power supplier. Connection is then initiated, validated or reopened to the power grid.

In one particular embodiment, recharging of the customer account is made through the power grid. In still another particular embodiment, recharging of the customer account is made through wireless connection means, e.g. WiFi.

In still another particular embodiment, warning on limited account, over-consumption of power or insufficient charging in the account can be sent to the customer by SMS, e-mail or directly to the display of the domestic unit also at the customer's request.

In still another particular embodiment the smart card comprises data storage and processing functionalities for storing and processing relating data power-consuming activities. In still another particular embodiment, the data processing timetionalities of the smart card enable issuing periodic power-consumption reports to the customer and to the power supplier.

In still another embodiment, the smart card comprises advanced software functionalities for partitioning household consumption according to consumers/clients, loads, rooms or appliances.

In still another embodiment, the domestic unit comprises display means for displaying power consumption data numerically or graphically according to KWh or equivalent charge. In still another embodiment, the display is on a user-friendly screen.

In still another embodiment, the domestic unit further comprises interface means that enable programming the different functionalities of the smart card. In one particular embodiment, the interface may be a virtual or physical keypad that comprises different functionalities. In still another particular embodiment, the keypad comprises 0-9 key numbers, enter, delete, set/disable alarm keys, menu and operate keys.

In still another particular embodiment, the domestic unit comprises a clock and timer for setting times for operation or shutdown of power-consuming or power-depending activities in the household, plant, factory, office, workplace and the like. In still another embodiment, the domestic unit is configured to receive updates from the control computer of the power supplier. In still another embodiment, such updates are date and hour that are automatically updated by the control computer of the power supplier.

In one embodiment of the present invention, the domestic unit is configured to respond to household power consumption habits and control a plurality of consumers or power consumption points in a household.

In still another embodiment of the present invention, the central power supply line of the power supplier is connected to the domestic unit. The consumers in the household connect according to distribution of appliances, utilities, loads or rooms in order to provide an updated status report of power supply and consumption in terms of money value or KWh. This provides the consumer the option of pre-calculated power consumption according to budget and capabilities.

In one embodiment, the domestic unit is contained in an encasement that is break-proof. Such encasement of the domestic unit is kept locked. It can be unlocked only by a qualified, registered, authorized personnel or technician of the power supplier and only with a dedicated key. The limited access keeps the domestic unit hermetically locked and secure from tampering with it. In a still particular embodiment, every unlocking of the domestic unit is automatically registered at the smart card by date and exact hour of the day in order to prevent manipulation and power theft.

in one particular embodiment, the domestic unit comprises digital switches and keyboard that are automatically fluorescent in absence of external artificial or natural light or during power shutdown. In still another embodiment, the switches are isolated from each other, each switch directs to a different area in the household or according to power consumers, appliances, loads or utilities in the household.

In a further particular embodiment of the present invention, the domestic unit is controlled from a distance using a remote control. In one particular embodiment, the domestic unit may be operated remotely from a cell phone or a portable phone in a car/vehicle. This enables to turn the power in the household on or off in real-time, e.g., to turn off unsupervised appliances in a household or turn on appliances according to a desired schedule (boiler, lights, ovens, washing machine and the like). In still another embodiment, the domestic unit may produce digital report on real-time power consumption according to a command delivered from a remote control, a cell phone or a portable phone in a car/vehicle and transmit it directly to a local or remote computer, cell phone or portable phone in a car/vehicle.

In one embodiment, the domestic unit comprises a central on/off push button that turns off the unit in a single push in emergency or potentially hazardous electrocution of household residents or plant, factory, office workers or employees.

In a further embodiment the domestic unit is configured to switch to power saving mode, turning off non-imperative appliances.

The power unit may also comprise a digit touch screen and additional functions such as enter or delete functions.

In one particular embodiment, the domestic unit is configured as a prepaid counter. Specifically, a customer of a power supplier can charge the unit according to needs and budget in an account opened at the power supplier and consume power according to the amount of money charged. The domestic unit can be recharged any time during operation. Payment can be made directly to the power supplier through the domestic unit, e.g., billing a credit card by inserting credit card number and other identifying data as required in a standard credit card payment; with cash at a post office or bank or any other available prepayment method.

In still another particular embodiment, the domestic meter is configured to retain power supply to a household, plant, factory, office, workplace and the like for low budget customers of a power supplier that use a prepaid mode even when power consumption exceeds the charge registered at the power supplier.

In still another embodiment, the domestic unit is identified with a unique identification serial number. Particularly, the domestic unit may communicate identifying data about itself to a power supplier in order to locate the address associated with it and its exact location. This capability can be used for example to dispatch a qualified crew to locate and fix malfunctions in the power consumption supervising system, the domestic or auxiliary unit, the communication between the two units or any other malfunctions associated with power supply lines at the local area of the household, plant, factory, office, workplace and the like. This capability also provides real-time warning of sabotaging the supervising system or power lines and ensures immediate action against it.

In still another embodiment, the domestic unit turns on a constant alarm upon identifying sabotage actions or attempts for power theft or unauthorized or unlawful use of power. The alarm can be shutoff only by qualified personnel of the power supplier, e.g., an electrician or technician employee of the power supplier.

In still another embodiment, the domestic unit comprises means for detecting malfunctions in the local or domestic power system.

In still another aspect, the supervising system of the present invention comprises a second auxiliary power metering unit (auxiliary unit) installed on the power line that transports power to a household, plant, factory, office, workplace and the like before the exit point of the local power supply line in the vicinity of the household, factory, plant, office, workplace and the like.

In one embodiment of the present invention, the auxiliary unit is configured to measure power, e.g. in KWh, that is transported from the local supply line to the household, plant, factory, office, workplace and the like and intercepted and monitored by the domestic unit.

In another particular embodiment of the present invention, the auxiliary unit transmits its power transport reading to a smart card that compares it with the reading of power consumption reading at the domestic unit. This is done as a precaution to prevent power theft or unauthorized or unlawful power consumption.

In still another embodiment of the present invention, a reading in the auxiliary unit that is higher than the reading of power consumption in the domestic unit sends an immediate report to the power supplier center warning on possible power theft or unlawful or unauthorized power consumption in the area, household, plant, factory, office, workplace and the like.

In one particular embodiment of the present invention, the auxiliary unit is connected before the exit point of power supply line of any area, e.g. county, state, city, neighborhood, street, block, single building or single resident, plant, factory, office, workplace and the like. In particular, isolated or private household, factory, plant, office or workplace can more easily be monitored and controlled by the co-operation of the domestic and auxiliary units.

In still another embodiment of the present invention, the auxiliary unit is contained in a safety encasement that is configured to resist breaking or unauthorized or unlawful breach and tampering with the auxiliary meter. In one particular embodiment, the safety encasement is monolithic without any opening and does not enable access to the auxiliary power meter within it. In this embodiment, access to the auxiliary power meter is enabled only by irreversible catastrophic destruction of the encasement. Alternatively, the encasement is made of two or more parts attached to each other with bolts.

In still another particular embodiment, the auxiliary unit comprises sensing means communicating with the inner walls of the safety encasement that senses attempts to compromise the integrity of the safety encasement and transmits a distress signal to the power supplier and/or initiates a vocal alarm to deter the person attempting to break the safety encasement.

In still another particular embodiment, the encasement of the auxiliary unit can be opened only by transmitting a unique opening code to the auxiliary meter by qualified personnel of the power supplier. In another particular embodiment, the encasement can be opened mechanically, e.g., with means to unscrew the bolts that hold the parts of the encasement attached to each other.

In all options detailed above, in one particular embodiment of the present invention the auxiliary meter and the smart card contained within it lock upon attempts to breach the integrity of the safety encasement. This prevents tampering with the auxiliary unit and attempts for power theft or unauthorized or unlawful consumption of power.

In still another embodiment of the present invention, the auxiliary unit comprises communication means for communicating with the domestic unit or the control center of the power supplier. In particular, the communication means may be wireless, e.g., WiFi, wired or through the power grid itself.

In still another embodiment, the supervising system further comprises a routing box that is installed between the domestic and auxiliary units that controls and monitors power consumption of a plurality of customers at a defined geographic area.

In one aspect, the present invention provides a power consumption supervising network comprising a plurality of supervising systems, the plurality of the supervising systems comprising:
a plurality of domestic units; and
a plurality of auxiliary units,
wherein each one of the plurality of domestic units is installed at the premises of a power consumer and communicates with an auxiliary unit most adjacent to the domestic unit over the power grid and with the control center of the power supplier,
wherein the plurality of auxiliary r units is deployed over a power grid of a power supplier at each exit point that supplies power,
wherein each auxiliary power unit at each exit point comprises communication functionalities to communicate with auxiliary power units installed at adjacent exit points on the power grid and transmit power supply data registered in the auxiliary power unit.

In one embodiment of the present invention, the plurality of auxiliary units forms a network of power meters deployed over an entire grid of a power supplier and cover the power lines from the power line exit points nearest the premises or facilities of the power consumers to the main exit point at power plant of the power supplier.

In still another embodiment of the present invention, the auxiliary units are installed at each exit point of a power line nearest any area, such as county, state, city, neighborhood, street, block, single building or single resident, plant, factory, office, workplace and the like. In another aspect, the present invention provides a method for preventing power theft or unlawful or unauthorized use of power comprising:
monitoring and registering power consumption with a domestic power unit;
registering power supply at an auxiliary power unit installed at the exit point of a power line transporting power intercepted at said domestic power unit;
communicating the registered power supply to a remote computer at a control center of a power supplier;
comparing said power consumption at the domestic unit to the power supply at the auxiliary unit;
confirming that power consumption value does not exceed the power supply value, and in the negative case
disabling power supply to a household, plant, factory, workplace and the like in which said domestic unit is installed.

In one embodiment the method of the present invention further comprises setting off an alarm and/or a distress signal upon attempts to tampering with said domestic unit or said auxiliary unit.

### BRIEF DESCRIPTION OF THE DRAWINGS

FIG. 1 is a schematic illustration of a power supervising system.

FIG. 2 is a schematic illustration of a network of power supervising systems deployed over a power grid.

FIG. 3 is a flow diagram showing the method of monitoring and supervising power consumption.

### DETAILED DESCRIPTION OF PREFERRED EMBODIMENTS

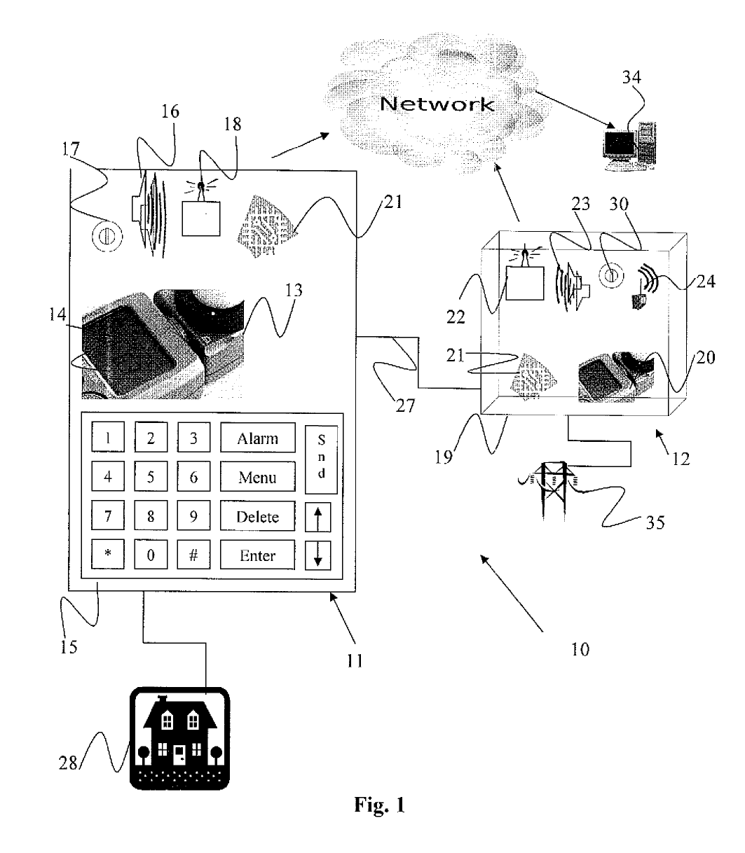

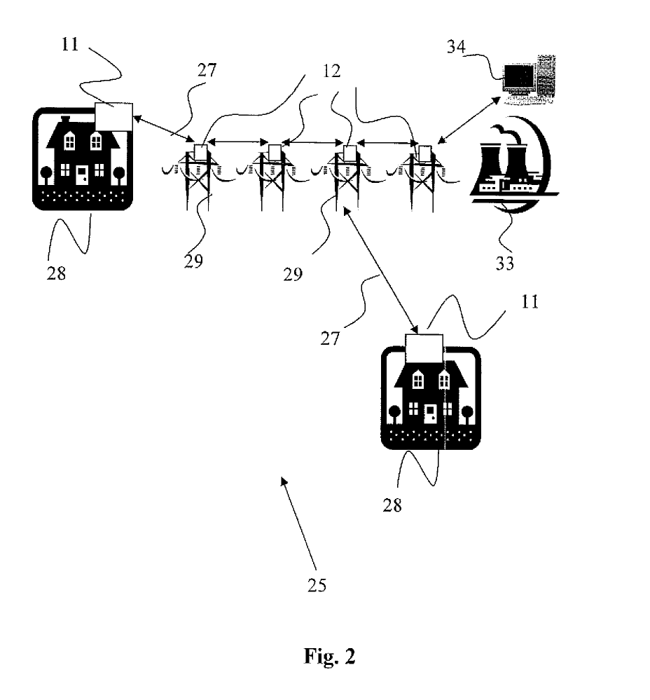

FIG. 1 is a schematic illustration of a power supervising system (10). The system comprises a domestic power metering unit (domestic unit) (11) and an auxiliary power metering unit (auxiliary unit) (12). The domestic unit is located at the entrance point of the power line to a household (28). A digital power meter (13) for monitoring and registering power consumption in KWh, a digital display (14) showing current counting and additional data related to power consumption, current status of customer account at the power supplier, current reading, messages received from the power supplier and automatic messages from the domestic meter (11) such as alarm on possible tampering with the meter. The domestic unit (11) also comprises data storage and processing means (21), e.g. smart card, and a keypad (15) that can be virtual or physical. For a virtual keypad the display of the domestic unit (11) comprises a touch screen. Further features of the domestic unit (11) comprise an audible alarm (16). Alternatively or additionally, the domestic unit (11) comprises a visual alarm (17) such as a lamp. The domestic unit (11) also comprises communication means (18) for communicating with the auxiliary unit (12) and the power supplier (shown in FIG. 2). When setting the alarm (16), (17), off the domestic unit (11) also sends a distress signal through communication means (18) to a computer (34) at the control center of the power supplier, which is identified as an attempt to tamper with the meter (11). The distress signal can be sent through wireless means (18), or directly through the power grid (35).

The auxiliary unit (12) comprises a safety encasement (19) that contains a digital power meter (20), data storage and processing means (21) communication means (22) for communicating with the domestic unit (11) and the power supplier and alarm means (23). The alarm means (23), preferably audible alarm but may also be audible and visual alarm (30), is set off when sensing means (24), which monitors the encasement (19) is activated upon attempts to breach the integrity of the encasement (19). The encasement (19) itself may be monolithic or made from two or more parts strongly attached to each other with bolts. In a certain application, the data storage and processing means (21) is encoded to turn off the sensing means (24) that monitors the encasement (19), enable the opening of the encasement (19) and allow access to the digital meter (20). In another application, the communication means (22) is capable of communicating wirelessly with external communication means to enable retrieving the reading stored in the digital meter (20) without opening the encasement (19). This enables retrieving real-time and onsite data on power supply at the exit point of in the power grid (35) on which the auxiliary unit (12) is installed without compromising the integrity of the auxiliary unit (12).

FIG. 1 also illustrates a schematics of display screen (14) of the domestic unit (11) showing the different functionalities of the domestic unit of the power supervising system (10). As can be seen, the display screen contains a keypad (15), virtual or physical, with keys such as 0-9 number keys, enter, delete, print keys, and back and forth arrow keys to browse through a menu of commands imbedded in a smart card of the domestic unit (11),

FIG. 2 illustrates schematically the locations of installation of the supervising system (10) on the power grid (25). The domestic unit (11) is located at the entrance point of the power line (27) to the power system of the household (28). The location of the domestic unit (11) is the same for any selected premises, e.g., a plant, factory, office, workplace and the like. The auxiliary unit (12) is located at the nearest exit point (29) of the power grid that supplies power to the household (28). The location of the auxiliary unit (12) on the grid (25) intercepts and registers the accurate amount of power supplied by the nearest power line (27) that controls the particular area or household. This amount of power is then registered at the auxiliary unit (12) and transmitted to the power supplier through the power grid (25) or other communication means. The reading of the power supply at the auxiliary unit (12) is then compared to the reading of the power consumption at the domestic unit (11) of the household. Any difference between the two readings suggests a malfunction in power supply. In particular., a difference in favor of the power consumption suggests possible power theft or unlawful or unauthorized consumption of power.

To secure accurate readings and prevent pirate connecting to the power grid, a network of power supervising systems can be deployed over the entire power grid. FIG. 2 schematically illustrates such network of power supervising systems (10). The domestic units (11) are installed in the household and a plurality of auxiliary units (12) is deployed at every exit point (27) of the end power lines (29) that controls the power supply in the vicinity of their particular areas. This ensures detecting any breach or pirate connecting to the power grid in real-time and registering accurate readings of power consumption by the customers. Not less importantly, comparing power consumption reading at the domestic unit (11) and power supply reading at the auxiliary unit (12) enables to detect power theft, or unlawful or unauthorized connecting to the power grid.

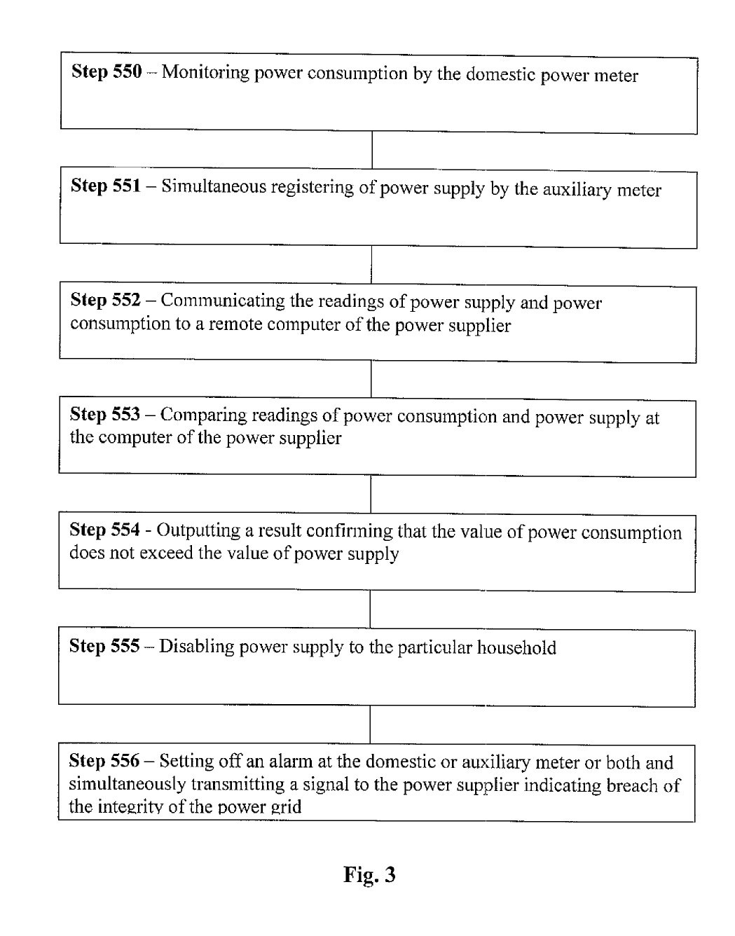

The flow diagram in FIG. 3 shows schematically the major steps of monitoring and supervising power consumption. In Step 550 power consumption is monitored by the domestic power unit. Simultaneously, power supply is registered by the auxiliary unit in Step 551. The readings in the domestic and auxiliary units are synchronized with each other to ensure proper comparison at the same points in time. In Step 552 the readings of power supply and power consumption are communicated to a remote computer at the control center of the power supplier. The computer of the power supplier compares the readings, Step 553, and outputs a result confirming that the value of power consumption does not exceed the value of power supply, Step 554. In case of failure of confirmation, the supervising system initiates Step 555, in which the power supply to the particular household is disabled. In a further Step 556, the domestic unit, auxiliary unit or both sets off an alarm, audible, visual or both, and simultaneously transmits a signal to the power supplier indicating breach of the integrity of the power grid. The above steps of comparing and confirming readings, disabling power supply and setting off an alarm apply also to any two auxiliary units installed on any adjacent exit points of the power grid. This ensures real-time report of any attempts to breach the integrity of the power grid at any point and essentially keep it intact.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A power supervising system comprising a domestic unit and at least one auxiliary unit, said domestic unit comprising: digital power meter; data reading, storage and processing means; tampering preventing means; display means; alarm means and communication means for communicating with said at least one auxiliary unit or with a control center of a power supplier;
said at least one auxiliary unit comprising: an encasement; breach sensing means;
digital power reading and data storage means; communication means for communicating with said domestic unit or said control center of said power supplier.

2. The power supervising system of claim 1, wherein said domestic unit further comprising a keypad, said keypad may be physical or virtual.

3. The power supervising system of claim 2, wherein said keypad is virtual and said domestic unit further comprising a touch screen.

4. The power supervising system of claim 1 Further comprising digital payment means.

5. The power supervising system of claim 1, wherein said communication means is selected from landline communication means, wireless communication means and communication means over a power grid of said power supplier.

6. The power supervising system of claim 1 further comprising a routing box that is installed between the domestic and auxiliary units that controls and monitors power consumption of a plurality of customers at a defined geographic area.

7. The power supervising system of claim 1, wherein said data reading, storage and processing means is a smartcard.

8. The power supervising system of claim 7, wherein said smartcard comprises communication functionalities enabling the unit to communicate with an auxiliary unit or with the power supplier, payment functionalities enabling prepayment for power consumption, setting functionalities enabling to insert settings of monitoring, supervising, operating and shutting off of power-consuming or power-depending activities in the household, plant, factory, office, workplace and the like, functionalities for accumulating data on power consumption and analyzing this data according to the different appliances and/or loads used or according to daily, weekly, monthly or seasonally periods of time.

9. The power supervising system of claim 1, wherein said domestic unit is identified with a unique identification serial number.

10. The power supervising system of claim 8, wherein said domestic unit is configured to communicate identifying data about itself to a power supplier in order to locate the address associated with it and its exact location.

11. The power supervising system of claim 1, wherein said domestic unit comprises means for detecting malfunctions in the local or domestic power system.

12. The power supervising system of claim 1, wherein said domestic unit is configured to inform about a limited account, over-consumption of power or insufficient charging in the account to a customer of a power supplier by SMS, e-mail or directly to the display of said domestic unit.

13. The power supervising system of claim 1, wherein said domestic unit is configured to monitor separately the metering of appliances, utilities, loads or rooms in a household, plant, factory or workplace and provide an updated status report of power supply and consumption in terms of money value or KWh.

14. The power supervising system of claim 1, wherein said domestic unit further comprises an emergency button, said emergency button is configured to disable power supply, in particular in hazardous cases of electrocution.

15. The power supervising system of claim 1, wherein said auxiliary unit is configured to connect before the exit point of a power supply line of any area, preferably said area is selected from county, state, city, neighborhood, street, block, single building or single resident, plant, factory, office and workplace.

16. The power supervising system of claim 1, wherein said encasement of said auxiliary unit is monolithic or comprises two or more parts, said parts are attached to each other with bolts.

17. The power supervising system of claim 16, wherein said encasement is configured to open mechanically or with transmission of a code.

18. The power supervising system of claim 1 configured to monitor and control power consumption of isolated or private household, factory, plant, office or by the co-operation of said domestic and auxiliary units.

19. The power supervising system of claim 1, wherein said domestic unit is configured to receive updates from the control computer of the power supplier.

20. The power supervising system of claim 1, wherein said updates are date and hour that are automatically updated by the control computer of the power supplier.

21. A power consumption supervising network comprising a plurality of supervising systems, said plurality of said supervising systems comprising
a plurality of domestic units; and
a plurality of auxiliary units,
wherein each one of the domestic unit is installed at the premises of a power consumer and comprises communication functionalities for communicating with an auxiliary unit most adjacent to the domestic unit over a power grid and with a control center of a power supplier,
wherein said plurality of auxiliary units is deployed over the power grid of said power supplier at each exit point that supplies power,
wherein each auxiliary power unit at each exit point comprises communication functionalities to communicate with auxiliary power units installed at adjacent exit points on the power grid and transmit power supply data registered in the auxiliary power unit.

22. A method for preventing power theft or unauthorized use of power comprising:
monitoring and registering power consumption with a domestic unit of a power consumption supervising system;
registering power supply at an auxiliary unit installed at an exit point of a power line transporting power intercepted at said domestic power unit;
communicating the registered power supply to a remote computer at a control center of a power supplier;
comparing said power consumption at said domestic unit to the power supply at the auxiliary power unit;
confirming that power consumption value does not exceed the power supply value, and in the negative case
disabling power supply to a household, plant, factory, workplace and the like in which said domestic power unit is installed;
setting off an alarm at said domestic unit; and
transmitting a distress signal to said control center of said power supplier.
